(19) United States
(12) Patent Application Publication
(10) Pub. No.: US 2014/0129233 A1
(43) Pub. Date: May 8, 2014

(54) APPARATUS AND SYSTEM FOR USER INTERFACE

(71) Applicant: ELECTRONICS AND TELECOMMUNICATIONS RESEARCH INSTITUTE, Daejeon (KR)

(72) Inventors: Eui Sok CHUNG, Daejeon (KR); Yun Keun LEE, Daejeon (KR); Hyung Bae JEON, Daejeon (KR); Ho Young JUNG, Daejeon (KR); Jeom Ja KANG, Daejeon (KR)

(73) Assignee: Electronics and Telecommunications Research Institute, Daejeon (KR)

(21) Appl. No.: 13/853,855

(22) Filed: Mar. 29, 2013

(30) Foreign Application Priority Data
Nov. 8, 2012 (KR) 10-2012-0125934

(51) Int. Cl. G06F 3/01; G06F 3/033; G10L 15/22

(52) U.S. Cl. CPC G06F 3/011; G10L 15/22; G06F 3/033
USPC 704/275; 345/163

(57) ABSTRACT

Disclosed is apparatus and system for user interface. The apparatus for user interface comprises a body unit including a groove which is corresponding to a structure of an oral cavity and operable to be mounted on upper part of the oral cavity; a user input unit receiving a signal from the user's tongue in a part of the body unit; a communication unit transmitting the signal received from the user input unit; and a charging unit supplying an electrical energy generated from vibration or pressure caused by movement of the user's tongue.

### CROSS-REFERENCE TO RELATED APPLICATIONS

This application claims priority to and the benefit of Korean Patent Application No. 10-2012-0125934 filed in the Korean Intellectual Property Office on Nov. 8, 2012, the entire contents of which are incorporated herein by reference.

### TECHNICAL FIELD

The present invention relates to an apparatus for user interface to substitute a mouse of a personal pc and a touch pad, and more particularly, to an apparatus and a system for user interface apparatus to be mounted on user's oral cavity.

### BACKGROUND ART

In current computer, data input process is performed through a user interface comprising a wire/wireless mouse under GUI (Graphic User Interface). Almost users of computer use a mouse as input mean.

However, in case that it is uncomfortable for a user to use a hand or there is a need for more convenient interface, as it is not efficient to use the mouse as a user interface, new technologies to substitute the mouse have been required and developed. Also, technique for controlling a cursor or clicking a mouse using a eye motion has been developed, however as it is necessary to detect the motion of eye in detail and to make a calculation process to control the cursor, there exist some problems to be solved, including a burden of expenses and technical problems according to a complicated system development.

And, it is not easy to apply a mouse control technique of a common personal computer and a touch control technique of tablet PC and smart phone to wearable computing environment.

### SUMMARY OF THE INVENTION

The present invention has been made in an effort to solve the above mentioned problems, and the present invention provides a mousepiece controller that may be mounted on user's oral cavity, maintaining an intuitive propriety and simplicity of augmented reality technique.

The present invention also provides an apparatus for user interface for a person having difficulties in using a hand.

An exemplary embodiment of the present invention provides an apparatus for a user interface comprising: a body unit including a groove which is corresponding to a structure of an oral cavity and operable to be mounted on upper part of the oral cavity; a user input unit receiving a signal from the user's tongue in a part of the body unit; a communication unit transmitting the signal received from the user input unit; and a charging unit supplying an electrical energy generated from vibration or pressure caused by movement of the user's tongue.

The user input unit may further comprise a movement sensing unit operable to detect a movement of the user's tongue; and a touch sensor operable to detect a touch input of the user's tongue, and wherein the signal which the user input unit receives comprises a signal generated from movement or touch input of the user's tongue.

The apparatus for user interface may further comprise a microphone receiving a user voice signal, and the communication unit transmits the user voice signal.

The apparatus for user interface may further comprise a speaking unit operable to play the signal received by the communication unit.

The apparatus for user interface may further comprise a storage battery unit which stores an electrical power generated by the charging unit, and supplies the stored electrical power.

The movement sensing unit is included in a part of the body unit corresponding to the user's oral cavity and operable to detect the movement of the user's tongue in the part of the body unit.

The touch sensor is included in a part of the body unit corresponding to the user's front tooth, and operable to detect the user's touch input in the part of the body.

The charging unit is included in a part of the body unit which is against the user's back tooth, and supplies the electrical energy generated from vibration or pressure caused by movement of the user's tongue in the part of the body.

An exemplary embodiment of the present invention provides a user interface system comprising: an apparatus of user interface which receives a signal from a user's tongue in a part of a body unit including a groove which is corresponding to a structure of an oral cavity and operable to be mounted on upper part of the oral cavity and transmits the received signal; and a wearable computer which provides a visual information to the user and has a shape of glasses.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is a prospective view of an apparatus for user interface according to an exemplary embodiment of the present invention.

FIG. 2 is a plane view of an apparatus for user interface according to an exemplary embodiment of the present invention.

FIG. 3 is a cross-sectional view of an apparatus for user interface according to an exemplary embodiment of the present invention.

FIG. 4 is an exemplary diagram showing a user usage according to an exemplary embodiment of the present invention.

FIG. 5 is an exemplary diagram of a user interface system according to an exemplary embodiment of the present invention.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Hereinafter, exemplary embodiments of the present invention will be described in detail with reference to the accompanying drawings.

Contents below are simple examples of a principle of the invention. Accordingly, a person skilled in the art may implement the principle of the invention and invent various apparatuses included in a concept and a scope of the invention although it is not clearly described or illustrated in the present specification. All conditional terms and exemplary embodiments enumerated in the present specification have a clear intention only for the purpose of understanding the concept of the invention in principle, and shall not be understood that the conditional terms and exemplary embodiments are limited to the specially enumerated exemplary embodiments and state.

All statements herein reciting principles, aspects, and embodiments of the invention, as well as specific examples thereof, are intended to encompass both structural and functional equivalents thereof. Additionally, it is intended that such equivalents include currently known equivalents as well as equivalents developed in the future, i.e., any elements developed that perform the same function, regardless of the structure.

The aforementioned objects, characteristics, and advantages will be more apparent through the detailed description below related to the accompanying drawings, and thus those skilled in the art to which the present invention pertains will easily implement the technical spirit of the present invention. In the following description, a detailed explanation of known related functions and constitutions may be omitted so as to avoid unnecessarily obscuring the subject matter of the present invention. Hereinafter, exemplary embodiments according to the present invention will be described in detail with reference to the accompanying drawings.

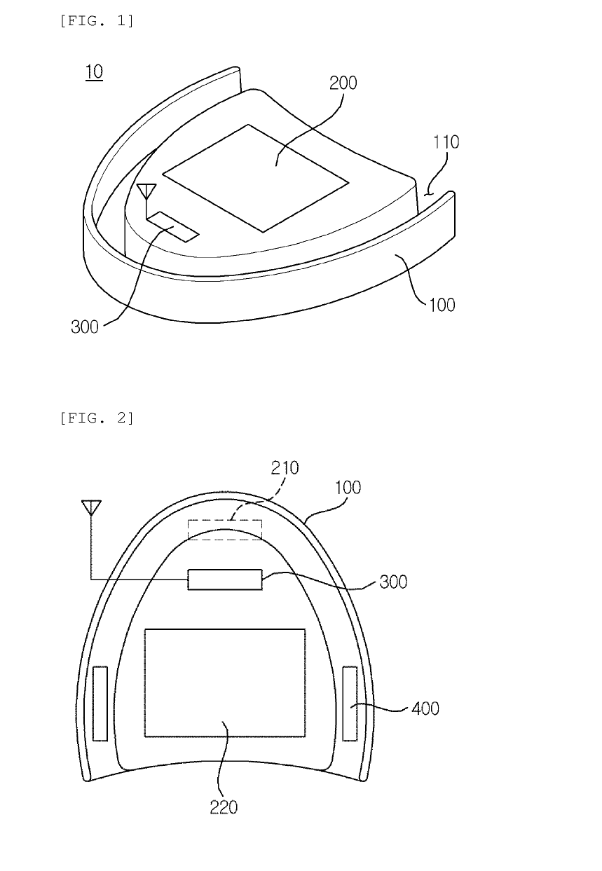

FIG. 1 is a perspective view illustrating a structure of an apparatus for user interface according to an exemplary embodiment of the present invention.

Referring FIG. 1, an apparatus of user interface (10) according to an exemplary embodiment of the present invention includes a body unit (100), a user input unit (200) and a communication unit (300).

The body unit (100) includes a groove (110) which is corresponding to a structure of an oral cavity and the body units is operable to be mounted on upper part of the oral cavity. Preferably, the body unit (100) has a shape of a mouse piece so that the body unit may prevent damage of inner mouth and teeth effectively.

The user inserts the groove (110) into teeth so that the body unit (100) may be mounted on upper part of the oral cavity. The structure and shape of the groove (110) depends on a set of user's teeth, thus it may have different widths and length according to the set of user's teeth. Preferably, if it is possible to obtain 3D position information of set of user's teeth, the groove may be made more accurately, based on the 3D position information.

Further, the body unit (100) plays a role of a housing including components which are used to implement the apparatus of user interface (10). And, if the body unit (100) is prepared as a replaceable type, the damage of the user's body and interface components caused by abrasion may be prevented effectively.

The explanation for interface components which are included in the body unit (100) is as follows.

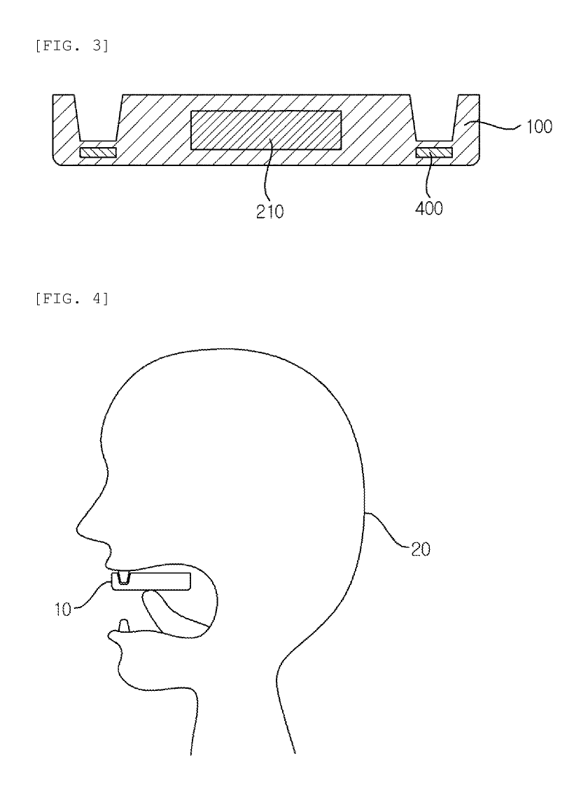

A user input unit (200) receives a signal from the user's tongue which is located on a part of the body unit (100). Referring FIG. 1, preferably, the user input unit (200) is located on one side of the body unit (100) that the user's tongue may contact. Referring FIG. 2, FIG. 2 is a plane view illustrating the user interface (100), and the user input unit (200) includes a touch sensor (210) and a moving sensing unit (220).

The movement sensing unit (220) is operable to detect a movement of the user's tongue. The movement sensing unit (220) is mounted on a side corresponding to the roof of the user's mouth so that the user may touch his tongue on one or some parts of the user input unit (200) or may make a motion/gesture.

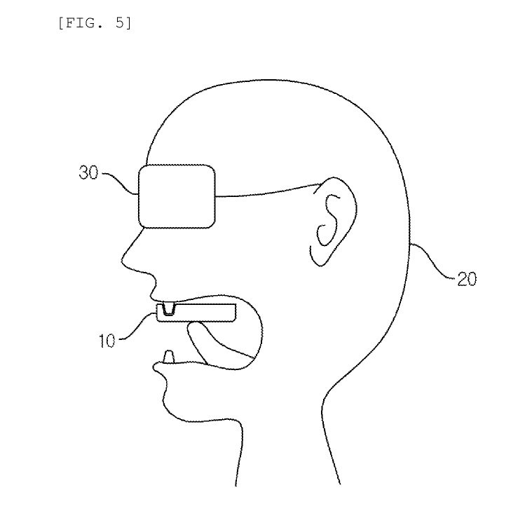

FIG. 4 illustrates a concept of touching the user's tongue on one side of the user input unit (200). Referring FIG. 4, an apparatus for user interface may interwork with a user device, such as PC, cellar phone and wearable computer. The user (20) could recognize and touch a display screen of a user device, or touch one point of the display screen by his hands, or touch one point of the movement sensing unit (220) by his tongue like the user selects one point of display screen through a mouse cursor. Therefore, in the present embodiment, it is desired that a side of the user input unit (200) corresponds with the display screen.

Also, a concept of making a gesture motion is exemplified by inputting a predetermined interface commands according to a motion pattern which is resulted from a movement of the user's mouth contacted with one side of the user input unit (200), similar to a gesture motion for touch pad and a mouse input action. For example, a movement of user's tongue to left or right side means a user command to turn a current page, and a movement to up or down means a user command for screen scrolling. And, of course, different or more complicated motions regarding other commands for exiting or starting a process could be predetermined and applied in the user input unit.

And, the touch sensor (210) detects and recognizes a touch input by the user's tongue which is independent on touch position such as a mouth click, except the touch input corresponds to the display screen of the user input unit (200).

Referring FIG. 2 and FIG. 3 illustrating a cross-sectional view of the apparatus for user interface according to the exemplary embodiment of the present invention, the touch sensor (210) is located in one side of the body unit (100), and detects the touch input by the user's tongue. The user inputs an interface command through touching one side of the body unit (100) as a mouse click.

For example, if an action of moving a pointer of a display screen to a position of tongue, or touching one side of the body unit (100) is detected by the touch sensor, the action may run a process corresponding to a mouse click command in the apparatus for user interface. And, in case of the user input unit (200) is divided into two regions, that is right and left region, the detected signal from the right region may run one processed corresponding to right clicking of the mouse and the detected signal from the left region may another process corresponding to left clicking of the mouse.

Further, the touch sensor (210) and the movement sensing unit (220) are components of the apparatus for user interface placed on the user's oral cavity, therefore a software which is applied to the user input unit had better be prepared to perform various actions depending on a command input condition. Though the same motions are detected by the user input unit, the interpretation for the motions may be differentiated depending on various command input conditions including the mouse condition. For example, a command input which is detected under open mouse condition may be interpreted differently from a command input under close mouse condition.

Referring FIG. 1, the apparatus for user interface according to the exemplary embodiment of the present invention, the apparatus for user interface includes the communication unit (300). The communication unit (300) transmits the signal received from the user input unit (200). As mentioned above, the apparatus for user interface may be prepared to have an interworking operation with a wearable computer. In case of that the user watches the display screen through the wearable computer, and contacts one portion of the movement sensing unit (220), the contact by the user is detected and the mean of the contact is interpreted by the user input unit, and the communication unit transmits the signal received from the user input unit to the wearable computer.

And, the communication unit (300) may receive the signal from the wearable computer. To interwork with the wearable computer, the communication unit (300) may receive a condition signal of the wearable computer and transmit an interface command regarding the received condition signal.

The apparatus for user interface may further comprise the charging unit (400). The charging unit (400) supplies an electrical energy generated from vibration or pressure caused by a movement of the user's tongue.

The charging unit (400) generates an electrical energy or power which is used to drive components included in the apparatus for user interface. Referring FIG. 2 and FIG. 3, the charging unit (400) is included in a part of the body unit which is against the user's back tooth, and supplies the electrical energy generated from vibration or pressure caused by a movement of the user's tongue.

Meaning of using the vibration or pressure caused by the movement of the user's tongue implies transferring a mechanical energy to an electrical energy. The charging unit (400) may generate an electrical energy based on a piezoelectric effect. The charging unit may generate an electric potential in response to correlation between mechanical and electrical state of materials having a crystal structure.

In other words, a mechanical change supplied to the materials causes a dielectric polarization, and the dielectric polarization originated from the movement of the user's tongue may make an electrical potential. The charging unit (400) may comprise a piezoelectric element such as crystal and tourmaline having a piezoelectric effect.

The apparatus for user interface according to the exemplary embodiment of the present invention may further comprise microphone which receives a user voice signal. The microphone may be used to detect a user interface input except for the touch input by user's tongue. The microphone may record the user voice signal, and send the user voice signal through the communication unit to the wearable computer, and the wearable computer may interpret the meaning of it and perform a process according the interpretation result. And, in case of that, it is desirable that the user voice signal is converted into an interface command as a result of voice recognition process.

The apparatus for user interface according to the exemplary embodiment of the present invention may further comprise a speaking unit. The speaking unit is operable to play the signal received by the communication unit (300). Therefore, the user may hear an audio signal from the wearable computer through the speaking unit without an ear phone or a head phone.

The above-mentioned microphone and speaking unit is not illustrated in FIGS. 1˜3, but they may be included in an appropriate position according the other interface structure of the body unit.

The apparatus for user interface according to the exemplary embodiment of the present invention may further comprise a storage battery unit which stores the electrical energy generated by the charging unit, and supplies the stored electrical energy. The apparatus for user interface may be formed to receive an electric power from a primary cell, but it is necessary to change the primary cell regularly. Therefore, preferably the apparatus for user interface further comprises a secondary cell such as a storage battery and an electric condenser.

Preferably, the storage battery may be implemented as a closed type considering the structure of the apparatus for user interface. The storage battery may be exemplified by a lead storage battery of a closed type using a complementary electrode or a platinum catalyst for water reduction physical-chemically, or an alkali accumulator comprising an anode having a nickel hydroxide and a cathode having an iron power or a mixture of Fe and Cd. An electric condenser which does not comprise a harmful component to prevent a human body from heavy metals is more preferable.

FIG. 5 illustrates an exemplary of user interface system comprising an apparatus for user interface according to the exemplary embodiment of the present invention.

The user interface system comprises an apparatus for user interface (10) and a wearable computer (30).

The apparatus for user interface (10) is mounted on upper part of a user's oral cavity, and has a body unit including a groove which is corresponding to a structure of the oral cavity and operable to be mounted on upper part of the oral cavity, and receives a user input signal from a part of the body unit, and transmits the signal other component. Each component of the user interface system corresponds to the above mentioned apparatus for user interface.

The apparatus for user interface (10) comprises a body unit (100), a user input unit (200), a communication unit (300) and a charging unit (400). The explanation for the components are skipped because every component is substantially equal to those of the above mentioned apparatus for user interface.

The wearable computer interworks the apparatus for user interface (10), and it may be implemented as a glasses type and may be operable to provide the user a display screen according to the received signal from the communication unit. And also, the wearable computer (30) may be mounted on glasses. Wherein, the apparatus for user interface (10) mounted on the user's oral cavity may interwork the wearable computer (30).

As an example of the interworking, the user inputs an interface command in various predetermined methods. The specified example of the interface command has been already described above.

According to the present invention, an apparatus for user interface may interwork with a computer through a controller mounted on the user's oral cavity, and may be used as a helpful interface for a person having a inconvenience in using hands.

As described above, the exemplary embodiments have been described and illustrated in the drawings and the specification. The exemplary embodiments were chosen and described in order to explain certain principles of the invention and their practical application, to thereby enable others skilled in the art to make and utilize various exemplary embodiments of the present invention, as well as various alternatives and modifications thereof. As is evident from the foregoing description, certain aspects of the present invention are not limited by the particular details of the examples illustrated herein, and it is therefore contemplated that other modifications and applications, or equivalents thereof, will occur to those skilled in the art. Many changes, modifications, variations and other uses and applications of the present construction will, however, become apparent to those skilled in the art after considering the specification and the accompanying drawings. All such changes, modifications, variations and other uses and applications which do not depart from the spirit and scope of the invention are deemed to be covered by the invention which is limited only by the claims which follow.

What is claimed is:

1. An apparatus for a user interface comprising:
a body unit including a groove which corresponds to a structure of an oral cavity and operable to be mounted on upper part of the oral cavity;
a user input unit receiving a signal from the user's tongue in a part of the body unit;
a communication unit transmitting the signal received from the user input unit; and
a charging unit supplying an electrical energy generated from vibration or pressure caused by movement of the user's tongue.

2. The apparatus for user interface of claim 1,
wherein the user input unit further comprises a movement sensing unit operable to detect a movement of the user's tongue; and a touch sensor operable to detect a touch input of the user's tongue, and
wherein the signal which the user input unit receives is generated by a movement or a touch input of the user's tongue.

3. The apparatus for user interface of claim 1,
wherein the apparatus for user interface further comprises a microphone receiving a user voice signal, and
the communication unit transmits the user voice signal.

4. The apparatus for user interface of claim 3,
wherein the apparatus for user interface further comprises a speaking unit operable to play the signal received by the communication unit.

5. The apparatus for user interface of claim 1,
wherein the apparatus for user interface further comprises a storage battery unit which stores the electrical energy generated by the charging unit, and supplies the stored electrical energy.

6. The apparatus for user interface of claim 2,
wherein the movement sensing unit is included in a part of the body unit corresponding to the user's oral cavity and operable to detect the movement of the user's tongue in the part of the body unit.

7. The apparatus for user interface of claim 2, wherein the touch sensor is included in a part of the body unit corresponding to the user's front tooth, and operable to detect the user's touch input in the part of the body.

8. The apparatus for user interface of claim 1,
wherein the charging unit is included in a part of the body unit which is against the user's back tooth, and supplies the electrical energy generated from vibration or pressure caused by movement of user's tongue in the part of the body.

9. A user interface system comprising:
an apparatus for user interface which receives a signal from a user's tongue in a part of a body unit including a groove which is corresponding to a structure of an oral cavity and operable to be mounted on upper part of the oral cavity and transmits the received signal; and
a wearable computer which provides a visual information to the user and has a shape of glasses.

10. The user interface system of claim 9, wherein the apparatus for user interface comprises,
a body unit including a groove which is corresponding to a structure of an oral cavity and operable to be mounted on upper part of the oral cavity;
a user input unit receiving a signal from the user's tongue in a part of the body unit;
a communication unit transmitting the signal received from the user input unit; and
a charging unit supplying an electrical energy generated from vibration or pressure caused by movement of the user's tongue.

11. The user interface system of claim 10, the user input unit further comprises a movement sensing unit operable to detect a movement of the user's tongue; and a touch sensor operable to detect a touch input of the user's tongue, and
wherein the signal which the user input unit receives comprises a signal generated from the movement or the touch input of the user's tongue.

12. The user interface system of claim 10, wherein the user interface system further comprises a microphone receiving a user voice signal, and
the communication unit transmits the user voice signal.

13. The user interface system of claim 12, wherein the user interface system further comprises a speaking unit operable to play the signal received by the communication unit.

14. The user interface system of claim 10, wherein the user interface system further comprises a storage battery unit which stores the electrical power generated by the charging unit, and supplies the stored electrical power.

15. The user interface system of claim 11, wherein the movement sensing unit is included in a part of the body unit corresponding to the user's oral cavity and operable to detect the movement of the user's tongue in the part of the body unit.

16. The user interface system of claim 11, wherein the touch sensor is included in a part of the body unit which is against user's front tooth, and operable to detect the user's touch input in the part of the body.

17. The user interface system of claim 10, wherein the charging unit is included in a part of the body unit corresponding to the user's back tooth, and supplies the electrical energy generated from vibration or pressure caused by movement of the user's tongue in the part of the body.
